(19) United States
(12) Patent Application Publication
(10) Pub. No.: US 2006/0220908 A1
(43) Pub. Date: Oct. 5, 2006

(54) Method and device for supporting the driver of a vehicle during an emergency braking

(76) Inventors: Uwe Petersen, Steinenbronn (DE); Volker Schmid, Stuttgart (DE); Thomas Unselt, Stuttgart (DE)

Correspondence Address: FITCH, EVEN, TABIN & FLANNERY, P. O. BOX 65973, WASHINGTON, DC, 20035, US

(21) Appl. No.: 10/566,834

(22) PCT Filed: Jul. 28, 2004
(86) PCT No.: PCT/EP04/08419

§ 371 Date: Apr. 14, 2006

(30) Foreign Application Priority Data
Aug. 5, 2003 (DE) 103 35 738.6

(51) Int. Cl. G08G 1/16

(52) U.S. Cl. 340/903; 701/70

(57) ABSTRACT

The invention relates to a method and device for supporting the driver of a vehicle during an emergency braking process in order to prevent the vehicle from colliding with an object which is located in a detection zone in front of the vehicle in the direction of travel, in particular a preceding vehicle. In the method according to the invention braking means for braking the vehicle (50) are actuated independently of the driver if a predefined emergency braking condition is met and if it is determined that the driver wishes to carry out the emergency braking process, emergency braking information to the driver of the vehicle (50) being issued when the emergency braking condition is met. According to the invention information to the driver is issued even when the emergency braking condition is not met, said information informing the driver of the vehicle (50) about the current situation in the surroundings or the traffic situation in the detection zone (54), the information to the driver being adjusted as a function of predefined information conditions being met.

The invention relates to a method and device for supporting the driver of a vehicle during an emergency braking process in order to prevent the vehicle from colliding with an object which is located in a detection zone in front of the vehicle in the direction of travel, in particular a preceding vehicle. For this purpose, braking means for braking the vehicle are actuated independently of the driver in order to carry out the braking process if a predefined emergency braking condition is met and if it is determined that the driver wishes to carry out the emergency braking process, emergency braking information to the driver of the vehicle being issued when the emergency braking condition is met.

The document DE 198 52 375 A1 discloses such a brake device for a vehicle. The brake device comprises a brake system and a distance-sensing apparatus which detects the distance from a preceding vehicle. The brake system may be activated either by the driver using a brake pedal or by a control apparatus independently of the driver. When the brake pedal is activated, the control apparatus checks whether the braking deceleration of the vehicle which is caused by the activation is sufficient to prevent a collision with the preceding vehicle. If this is not the case, the brake system is activated by the control device independently of the driver in such a way that a collision is prevented. Since the driver is not warned in advance, the intervention of the control apparatus into the brake system is surprising under certain circumstances.

The document JP 112 55 087 A discloses a brake assistance system for a vehicle. The brake assistance system has the purpose of preventing the vehicle from colliding with an object, in particular a vehicle which is stationary or traveling at a low speed in a detection zone in front of the vehicle in the direction of travel. If an immediate risk of a collision is detected by the brake assistance system and the driver of the vehicle simultaneously activates a brake pedal which is provided for actuating the braking means of the vehicle, the braking force which is brought about by the driver in the braking means using the brake pedal, and thus the braking deceleration of the vehicle, are increased automatically in such a way that the collision is avoided. When the immediate risk of a collision occurs, a warning is issued to the driver which indicates to the driver that there is a need to carry out the braking process by activating the brake pedal. It is disadvantageous that the brake assistance system only responds to the occurrence of an immediate risk of a collision, that is to say only responds when the vehicle is already in a critical situation. On the other hand, measures which support the driver and which have the objective of preventing the occurrence of the immediate risk of a collision are not provided.

The object of the present invention is to provide a method and a device of the type mentioned at the beginning with which measures are provided which support the driver and which have the objective of preventing an immediate risk of a collision occurring.

This object is achieved according to the features of patent claim 1 and of patent claim 11, respectively.

In the method according to the invention for supporting the driver of a vehicle during an emergency braking process in order to prevent the vehicle from colliding with an object which is located in a detection zone in front of the vehicle in the direction of travel, in particular a preceding vehicle, braking means which are provided for braking the vehicle are actuated independently of the driver if a predefined emergency braking condition is met and if it is determined that a driver wishes to carry out the emergency braking process, emergency braking information being issued to the driver of the vehicle when the emergency braking condition is met. Information to the driver is issued even when the emergency braking condition is not met, said information informing the driver of the vehicle about the current situation in the surroundings or the traffic situation in the detection zone, the information to the driver being adjusted as a function of one or more predefined information conditions being met. By suitably selecting the information conditions and the respectively associated information to the driver it is possible to provide the driver with messages about the relevance of the objects so that he has to adjust his driving style to the current situation in the surroundings or the traffic situation in order to counteract in a preventive fashion the occurrence of an immediate risk of a collision.

Advantageous embodiments of the method according to the invention emerge from the subclaims.

The objects located in the detection zone are advantageously detected, a positional variable which describes a spatial position of the respective object in relation to the vehicle and/or a relative speed variable which describes a relative speed between the vehicle and the respective object being determined for each detected object. The detection zone is determined by the type and design of the sensor means which are provided for determining the positional variables and/or the relative speed variable. The sensor means may be radar sensors or ultrasonic sound sensors which are conventional, and thus proven in terms of their function, said sensors being of the type which are used in vehicles in parking aids or distance-controlling systems. It is possible in particular to determine from the positional variable a distance variable which describes a distance between the vehicle and the respective object. The relative speed variable can be determined either by forming gradients or time derivatives of the distance variable or else by immediate measurement, for example on the basis of a Doppler shift detected by suitable sensor means. In addition to radar sensors it is also conceivable to use CCD cameras in a stereo arrangement or infrared distance sensors.

By evaluating the positional variables and/or relative speed variables which are determined for the objects it is possible to determine those objects which constitute obstacles for the vehicle with respect to its instantaneous driving course from the totality of detected objects. For this purpose, the driving tube taken up by the vehicle is determined on the basis of the instantaneous driving course. If it is detected on the basis of the positional variable that an object is within the driving tube, said object constitutes a potential obstacle for the vehicle. This reduces the risk that, for example, objects which are detected during cornering or during an avoidance maneuver such as roadway barriers, road signs located at the side of the roadway or the like being erroneously interpreted as being obstacles even though they are not in the driving tube. The instantaneous driving course and thus the driving tube are determined, for example, on the basis of a steering angle which is set at steerable wheels of the vehicle or a variable correlated thereto and the instantaneous travel speed of the vehicle.

Since only obstacles which approach the vehicle due to a negative relative speed are significant for a collision, it is possible, if appropriate, to restrict further the set of obstacles to be taken into account by evaluating the relative speed variable. Furthermore, each of the obstacles can be assigned a reliability value which describes the probability of the respective obstacle being located in the driving tube. The reliability value increases here with the time period for which the detected object in the driving tube has been known. For example, an object which is located in the driving tube is considered to be an actual obstacle only if the reliability value reaches a predefined minimum value so that the probability of objects which are erroneously interpreted as being an obstacle can be additionally reduced.

By evaluating the positional variables and/or relative speed variables which are associated with the obstacles it is possible to determine that obstacle which has the greatest relevance for a collision of the vehicle. For this purpose, a setpoint value of a braking deceleration variable is determined on the basis of the determined positional variables and/or the determined relative speed variables for each of the obstacles. The setpoint value of the braking deceleration variable indicates which braking deceleration is at least necessary to reliably prevent the vehicle from colliding with the respective obstacle. In particular that obstacle which requires the greatest braking deceleration then has the greatest relevance for a collision, which can be determined by simply evaluating the setpoint values of the braking deceleration variable which are determined with respect to the obstacles.

The emergency braking condition is advantageously predefined as a function of the determined positional variable and/or the determined relative speed variable. The same applies to the information conditions which are also predefined as a function of the determined positional variable and/or the determined relative speed variable. By evaluating the positional variable and/or the relative speed variable it is possible for the information to the driver to be easily and reliably adjusted to the current situation of the surroundings or traffic situation, in which case, in order to determine the positional variable and/or the relative speed variable it is possible also to use the previously described sensor means in a cost-saving fashion.

The information to the driver changes as the risk of a collision increases in order to clarify the corresponding urgency. This can be achieved by selecting suitable visual and/or acoustic and/or haptic signals. The respective type of signals can be determined on the basis of studies into the psychology of perception.

A driver's wish to carry out the emergency braking process can be reliably determined by evaluating the activation of a braking operator control element which is provided to enable the driver to influence the braking means of the vehicle, the braking operator control element being typically a brake pedal. In addition or alternatively to this it is also possible to evaluate in a corresponding manner the activation of a driving operator control element, for example an accelerator pedal, which is provided to enable the driver to influence drive means of the vehicle.

The emergency braking process is carried out in particular with the objective of bringing about a predefined safety distance between the vehicle and object and/or a predefined relative speed between the vehicle and object, the relative speed being preferably predefined as approximately zero. Thus, on the one hand the vehicle is prevented, in conjunction with the execution of the emergency braking process, from driving up too close behind the object, and on the other hand the travel speed of the vehicle is reduced by the emergency braking process only to the degree which is absolutely necessary to prevent the vehicle from colliding with the preceding vehicle. Any reduction in the travel speed beyond this is unnecessary and constitutes a considerable risk in particular for vehicles traveling behind.

The method according to the invention and the device according to the invention will be explained below in more detail with reference to the appended drawings, in which:

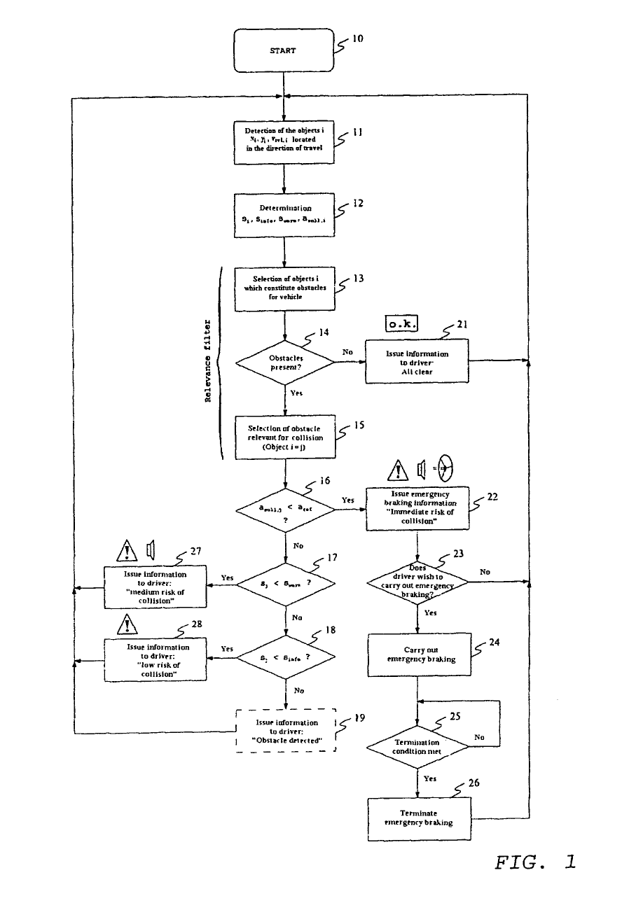

FIG. 1 shows an exemplary embodiment of the method according to the invention in the form of a flowchart,

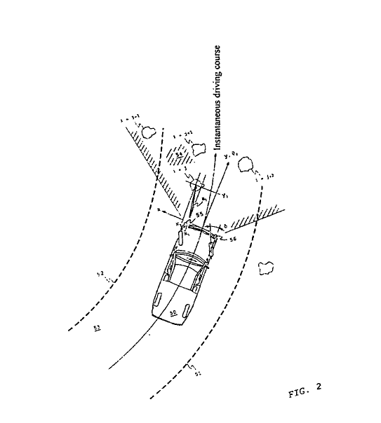

FIG. 2 shows a vehicle and a plurality of objects in schematic illustration in a plan view, and

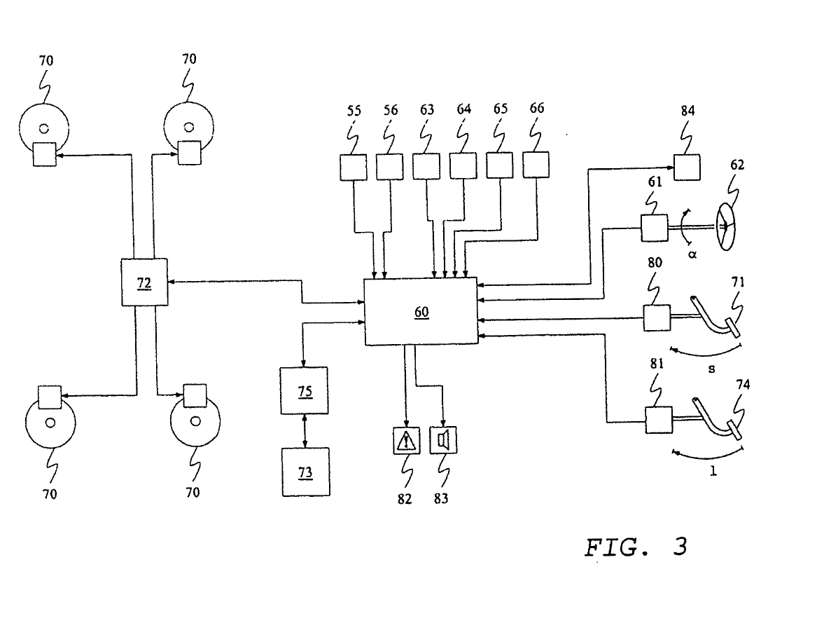

FIG. 3 shows a schematically illustrated exemplary embodiment of the device according to the invention.

FIG. 1 illustrates an exemplary embodiment of the method according to the invention in the form of a flowchart which will be described below with reference to FIG. 2. FIG. 2 shows an exemplary driving situation of a vehicle 50 which is equipped with the method according to the invention or the device according to the invention, with the vehicle 50 moving in the direction of the travel speed vector \vec{V}_{E} on a roadway 53 which is predefined by roadway boundaries 51, 52.

The method illustrated in FIG. 1 is started in a superordinate initialization step 10. In a subsequent first main step 11 the objects i=j−1, . . . , j+2 which are located in a detection zone 54 in front of the vehicle 50 in the direction of travel are detected. A positional variable which describes a spatial position xᵢ, yᵢ of the respective object i in relation to the vehicle 50, and a relative speed variable which describes a relative speed v_{rel,i} between the vehicle 50 and the respective object i are determined for each of the detected objects i=j−1, . . , j+2. The detection zone 54 is indicated by the hatching and is determined by the type and design of the sensor means 55, 56 which are provided for determining the positional variables and/or the relative speed variables.

In a second main step 12, a distance variable which describes a distance sᵢ between the vehicle 50 and the respective object i is determined from each of the positional variables. The distance sᵢ between the vehicle 50 and the respective object i which is relevant for a collision is obtained from the distance to be actually traveled by the vehicle 50 to the object i, that is to say ultimately from the instantaneous driving course of the vehicle 50. The instantaneous driving course is determined, for example, on the basis of a steering angle δ which is set at steerable wheels of the vehicle 50 and the instantaneous travel speed v_{f} of the vehicle 50. The distance variable is then determined, for example, on the basis of an approximation equation of the form
sᵢ≈\sqrt{(xᵢ−\hat{x}ᵢ)²+yᵢ²} (A1)
in which the correction term \hat{x}ᵢ represents a function of the instantaneous driving course,
\hat{x}ᵢ≡\hat{x}ᵢ(δ,v_{f}). (A2)

Alternatively, the distance variable is determined on the basis of an approximation equation which is completely sufficient for most cases and is of the form
sᵢ≈yᵢ. (A3)

Which of the two equations (A1) or (A3) is used depends ultimately on the required accuracy of the distance variable.

Furthermore, in the second main step 12, a setpoint value of a braking deceleration variable is determined as a function of the previously determined distance variables and relative speed variables for each of the objects i=j−1, . . . , j+2. The setpoint value of the braking deceleration variable indicates the braking deceleration a_{soll,i} with which a braking process must be at least carried out in order to reliably prevent the vehicle 50 from colliding with the respective object i. The setpoint value of the braking deceleration variable is determined on the basis of an equation of the form

$${a}_{soll , i} \approx \frac{1}{2} \frac{{v}_{rel , i}^{2}}{{s}_{i}} , \qquad ( A4 )$$

where a_{soll,i} represents that braking deceleration which is necessary to reduce both the relative speed v_{rel,i} and the distance sᵢ between the vehicle 50 and object i to essentially zero. If, on the other hand, the braking process has the objective of bringing about a predefined safety distance s_{O} and a predefined relative speed v_{rel,O}between the vehicle 50 and object i, equation (A4) is to be rewritten as

$${a}_{soll , i} \approx \frac{1}{2} \frac{{( {v}_{rel , i} - {v}_{rel , 0} )}^{2}}{( {s}_{i} - {s}_{0} )} \qquad ( A5 )$$

the equation (A5) ultimately constituting a generalization of the equation (A4).

In addition to the setpoint value of the braking deceleration variable, an information threshold value for the distance variable is determined as a function of the determined relative speed variables for each of the detected objects i=j−1, . . . , j+2, said determination being carried out specifically on the basis of an equation of the form

$${s}_{info} ∝ \frac{1}{2} \frac{{v}_{rel , i}^{2}}{{a}_{info}} , \qquad ( A6 )$$

and a warning threshold value for the distance variable, specifically on the basis of an equation of the form

$${s}_{warm} ∝ \frac{1}{2} \frac{{v}_{rel , i}^{2}}{{a}_{warn}} . \qquad ( A7 )$$

Here, the variables a_{info} and a_{warn} constitute predefined braking deceleration values which correspond to a weak or medium braking effect:
a_{info}≈0.1 . . . 0.25aₘₐₓ
a_{warn}≈0.25 . . . 0.8aₘₐₓ

The variable aₘₐₓ gives the maximum achievable braking deceleration. In conventional vehicles this is typically in the range between 7 and 10 m/s².

The distances s_{info} and s_{warn} which are described by the threshold values give those distances which the vehicle 50 must travel under the effect of the braking decelerations a_{info} or a_{warn} in order to reduce the relative speed v_{rel,i} to a value of essentially zero. If, on the other hand, a predefined relative speed v_{rel,O} is to be reached, equation (A6) is to be rewritten as

$${s}_{info} ∝ \frac{1}{2} \frac{{( {v}_{rel , i} - {v}_{rel , 0} )}^{2}}{{a}_{info}} \qquad ( A8 )$$

and equation (A7) is to be rewritten as

$${s}_{warn} ∝ \frac{1}{2} \frac{{( {v}_{rel , i} - {v}_{rel , 0} )}^{2}}{{a}_{warn}} \qquad ( A9 )$$

the equations (A8) and (A9) ultimately constituting generalizations of the equations (A6) and (A7).

In a third main step 13, those objects which constitute obstacles with respect to the instantaneous driving course of the vehicle 50 are determined from the totality of the detected objects i=j−1,. . . , j+2, with the driving tube which is taken up by the vehicle 50 being determined on the basis of the instantaneous driving course. If it is detected on the basis of the positional variable that an object i lies within the driving tube, it constitutes a potential obstacle for the vehicle 50. According to the example, the objects i=j−1, j+1, j+2 therefore constitute obstacles for the vehicle 50. Since only those obstacles which approach the vehicle 50—which is defined according to the example as a negative relative speed v_{rel,i}—are significant for a collision, the set of obstacles to be taken into account is, if appropriate, limited further by evaluating the relative speed variable. Furthermore, each of the obstacles is assigned a reliability value which describes the probability of the respective obstacle being located in the determined driving tube. The reliability value increases here with the time period for which the detected object i in the driving tube is known. For example, an object i which is located in the driving tube is considered to be an actual obstacle only if the associated reliability value reaches or exceeds a predefined minimum value.

In a subsequent fourth main step 14, it is checked whether obstacles have been determined in the preceding third main step 13. If this is the case, the process continues with a fifth main step 15 in which that obstacle which has the greatest relevance for a collision of the vehicle 50 is determined from the determined obstacles. In particular that obstacle which according to equation (A4) or equation (A5) requires the greatest braking deceleration a_{soll,i} which is described by the setpoint value of the braking deceleration variable has the greatest relevance. This generally corresponds to the obstacle with the smallest spatial distance sᵢ from the vehicle 50, that is to say the object i=j in the example.

If, on the other hand, it is detected in the fourth main step 14 that no obstacles have been determined in the third main step 13, corresponding information to the driver (“all clear”) is issued to the driver of the vehicle 50 in a first secondary step 21, the method sequence returning again to the first main step 10 in order to begin from the start. The information to the driver is issued, for example, by displaying a visual symbol or text with suitable color and form.

The fifth main step 15 is finally followed by a sixth main step 16 in which it is checked whether the braking deceleration a_{soll,j}—described by the setpoint value of the braking deceleration variable—of the object i=j which is detected as relevant exceeds a predefined limiting value a_{ref}. If this is the case, in a second secondary step 22 emergency braking information (“immediate risk of collision”) is issued to the driver of the vehicle 50 and said information requests the driver, with high urgency, to carry out without delay an emergency braking process by said driver activating the braking means of the vehicle 50 in order to prevent the collision. The limiting value a_{ref} constitutes here a predefined braking deceleration which corresponds to a high or very high braking effect:
a_{ref}≈1.0 . . . 1.5 a_{warn}

The emergency braking information is issued, for example, by displaying a visual symbol or text with suitable color or form and/or by issuing acoustic warning signals. In addition, it is also conceivable to issue a voice warning which indicates the immediately imminent risk of a collision and/or a haptic warning to the driving.

If it is detected in a third secondary step 23 that a driver wishes to carry out the emergency braking process, the emergency braking process is triggered in a fourth secondary step 14 by braking means of the vehicle 50 being actuated independently of the driver. Otherwise, the method sequence returns to the first main step 11.

The emergency braking process is not ended in a sixth secondary step 26 until a predefined termination condition is met, for example if the following applies:
sⱼ≈s_{O} and/or v_{rel,j}≈v_{rel,O}

After the emergency braking process has ended, the method sequence returns to the first main step 11 in order to begin again from the start.

If, on the other hand, it is detected in the sixth main step 16 that the braking deceleration a_{soll,j} which is described by the setpoint value of the braking deceleration variable does not exceed the predefined limiting value a_{ref}, the process continues with a seventh main step 17 in which it is checked whether the distance sⱼ which is described by the distance variable is greater than the distance s_{warn} which is described by the warning threshold value. If this is the case, in a seventh secondary step 27 corresponding information to the driver (“medium risk of a collision”) is issued, said information indicating to the driver with medium urgency that he should take suitable measures to reduce the risk of a collision, for example by braking or by means of an avoidance maneuver. The information to the driver is issued by displaying a visual symbol or text with suitable color or form and/or by issuing an acoustic warning signal. At the same time, the method sequence returns to the first main step 11.

If, on the other hand, the distance sⱼ which is described by the distance variable is not greater than the distance s_{warn} which is described by the warning threshold value, in a eighth main step it is checked whether the distance sⱼ which is described by the distance variable is greater than the distance s_{info} which is described by the information threshold value so that if this is the case corresponding information to the driver (“low risk of a collision”) is issued in a eighth secondary step 28 said information indicating to the driver with low urgency that he should take suitable measures to reduce the risk of a collision. The information to the driver is issued, for example, while displaying a visual symbol or text with a suitable color or shape.

If, on the other hand, it is detected in the eighth main step 18 that the distance sⱼ which is described by the distance variable is not greater than the distance s_{info} which is described by the information threshold value, information to the driver (“obstacle detected”), which indicates a negligible risk of a collision, is optionally issued in a ninth main step 19. At the same time, the method sequence returns to the first main step 11.

The information to the driver and the emergency braking information are issued alternately.

Finally, FIG. 3 shows a schematically illustrated exemplary embodiment of the device according to the invention for carrying out the method according to the invention. The device comprises both an evaluation unit 60 and the already mentioned sensor means 55, 56. The sensor means 55, 56 detect the objects i=j−1, . . . , j+2 which are located in the detection zone 54 in front of the vehicle 50 in the direction of travel, and generate signals from which the evaluation unit 60 determines the positional variable and/or the relative speed variable for each of the detected objects i=j−1, . . . , j+2. The sensor means 55, 56 are, for example, radar sensors or ultrasonic sound sensors such as are used in vehicles in parking aids or distance-controlling systems. The positional variables and/or relative speed variables are optionally determined in the sensor means 55, 56 themselves.

Knowledge of the instantaneous driving course is necessary to determine the distance variable according to equation (A1). Said driving course is determined by the evaluation unit 60 on the basis of the steering angle δ and the instantaneous travel speed v_{f}. The steering angle δ is determined by evaluating the signals of a steering wheel angle sensor 61. The steering wheel angle sensor 61 detects a steering wheel angle α which is set at a steering wheel 62 which is provided to enable the driver to influence the steering and which has a uniquely defined relationship with the steering angle δ. Furthermore, the travel speed v_{f} is determined by evaluating the signals of the wheel speed sensors 63 to 66 which detect the wheel speeds of the wheels of the vehicle 50.

As an alternative to the steering angle δ, it is also possible to use another variable which describes the lateral dynamics, for example the yaw rate. Instead of the longitudinal speed v_{f} it is also possible to use another variable which describes the longitudinal dynamics.

The braking means 70 which are provided to brake the vehicle 50 can be actuated, on the one hand, by the driver by activating a brake operator control means 71 and, on the other hand, can be activated independently of the driver at the instigation of the evaluation unit 60 by actuating a braking means controller 72 which interacts with the braking means 70. The braking means 70 are, for example, conventional hydraulic or pneumatic wheel brake devices.

The same applies to the drive means 73 which comprise, inter alia, the engine, transmission and clutch of the vehicle 50. The drive means 73 can be actuated both by the driver by activating a driver operator control means 74 and independently of the driver by means of the evaluation unit 60 by actuating a drive means controller 75 which interacts with the drive means 73. By suitably actuating the drive means 73, it is possible both to accelerate the vehicle 50 and to decelerate it by utilizing an engine drag torque which is exerted by the engine.

If the evaluation unit 60 determines that the emergency braking condition which is predefined in the main step 16 is met and that the driver wishes to carry out the emergency braking process, the evaluation unit 60 both causes the emergency braking information to be issued and brings about the triggering of the emergency braking process by actuating the braking means 70 and/or the drive means 73 independently of the driver.

The brake operator control element 71 is, for example, a brake pedal and the driving operator control element 74 is an accelerator pedal.

In order to determine whether a driver wishes to carry out the emergency braking process, the evaluation unit 60 evaluates the activation of the brake pedal and of the accelerator pedal by the driver, it being possible for this to be carried out using fuzzy logic. For this purpose, a brake pedal deflection s of the brake pedal which is brought about by the driver is detected by a brake pedal sensor 80 or an accelerator pedal deflection 1 of the accelerator pedal which is brought about by the driver is detected by an accelerator pedal sensor 81 and evaluated by the evaluation unit 60. The evaluation unit 60 then concludes, in particular, that the driver wishes to carry out the emergency braking process, if
the brake pedal deflection s and/or the increase in the brake pedal deflection s over time exceeds respectively predefined threshold values and/or if
the accelerator pedal deflection 1 drops below a predefined threshold value and/or the increase in the accelerator pedal deflection 1 over time exceeds a predefined threshold value.

The threshold values are determined, for example, on the basis of driving trials in which the activation of the brake pedal or accelerator pedal which is performed by different drivers is evaluated when there is a more immediate risk of a collision.

The emergency braking process is preferably carried out with a predefined emergency braking deceleration a_{NB}, with the emergency braking deceleration a_{NB} being applied by the evaluation unit 60 by correspondingly actuating the braking means 70 and/or the drive means 73. The emergency braking deceleration a_{NB} corresponds either to the braking deceleration a_{fahrer} which is predefined by the driver using the brake pedal or else to the braking deceleration a_{soll,j} which is described by the setpoint value of the braking deceleration variable, the larger of the two braking decelerations a_{fahrer} or a_{soll,j} being respectively used,
a_{NB}=max[a_{fahrer}, a_{soll,j}].

Even when the emergency braking condition is not met, the evaluation unit 60 causes information to the driver to be issued, the evaluation unit 60 adjusting the information to the driver as a function of the information conditions predefined in the main steps 14, 17 and 18.

In order to issue the information to the driver or the emergency braking information, visual signal transmitters 82 and/or audible signal transmitters 83 are provided. The visual signal transmitters 82 may be a display for displaying text information or warning symbols or may be other suitable visual display means. The acoustic signal transmitters may be embodied as a system for issuing voice warnings and/or warning tones. Haptic information to the driver or emergency braking information is issued, for example, in the form of rattling of a nail belt which is connected to the steering wheel 62, for which purpose a steering wheel actuator 84 which is connected to the steering wheel 62 is provided.

1. A method for supporting the driver of a vehicle during an emergency braking process in order to prevent the vehicle from colliding with an object which is located in a detection zone in front of the vehicle in the direction of travel, in particular a preceding vehicle, in which braking means (70) of the vehicle (50) for carrying out the emergency braking process are actuated independently of the driver if a predefined emergency braking condition (16) is met, emergency braking information to the driver of the vehicle (50) being issued when the emergency braking condition (16) is met, and in which information to the driver is issued even when the emergency braking condition (16) is not met, said information informing the driver of the vehicle (50) about the current situation in the surroundings or the traffic situation in the detection zone (54), the information to the driver being adjusted as a function of one or more predefined information conditions (14, 17, 18) being met, characterized in that the braking means (70) of the vehicle (50) for carrying out the emergency braking process are actuated independently of the driver if it is detected that a driver wishes to carry out the emergency braking process, and in that a positional variable which describes a spatial position (xᵢ, yᵢ) of the respective object (i) in relation to the vehicle (50) and/or a relative speed variable which describes a relative speed (v_{rel,i}) between the vehicle (50) and the respective object (i) is determined for each of the objects (i) located in the detection zone (54), in which case by evaluating the positional variables and/or relative speed variables which are determined those objects which constitute obstacles for the vehicle (50) with respect to its driving course are determined from the totality of the detected objects (i).

2. The method as claimed in claim 1, characterized in that by evaluating the positional variables and/or relative speed variables which are associated with the obstacles, that obstacle (j) which has the greatest relevance for a collision of the vehicle (50) is determined.

3. The method as claimed in claim 1, characterized in that the emergency braking condition (16) is predefined as a function of the determined positional variable and/or the determined relative speed variable.

4. The method as claimed in claim 1, characterized in that the information conditions (14, 17, 18) are predefined as a function of the determined positional variable and/or the determined relative speed variable.

5. The method as claimed in claim 1, characterized by visual and/or acoustic and/or haptic information to the driver.

6. The method as claimed in claim 1, characterized in that a driver's wish to carry out the emergency braking process is determined by evaluating the activation of a brake operator control element (71) which is provided to enable the driver to influence the braking means (70) of the vehicle (50).

7. The method as claimed in claim 1, characterized in that a driver's wish to carry out the emergency braking process is determined by evaluating the activation of a driving operator control element (74) which is provided to enable the driver to influence drive means (73) of the vehicle (50).

8. The method as claimed in claim 1, characterized in that the emergency braking process is carried out with the objective of bringing about a predefined safety distance (s_{O}) between the vehicle (50) and object (i) and/or a predefined relative speed (v_{rel,O}) between the vehicle (50) and object (i).

9. A device for supporting the driver of a vehicle during an emergency braking process in order to prevent the vehicle from colliding with an object which is located in a detection zone in front of the vehicle in the direction of travel, in particular a preceding vehicle, in which braking means (70) of the vehicle (50) are actuated independently of the driver in order to carry out the emergency braking process if an evaluation unit (60) detects that a predefined emergency braking condition (16) is met, with the evaluation unit (60) causing emergency braking information to be issued to the driver of the vehicle (50) when the emergency braking condition (16) is met, and in which the evaluation unit (60) causes information to the driver to be issued even when the emergency braking condition (19) is not met, said emergency braking condition (19) informing the driver of the vehicle (50) about the current situation in the surroundings or the traffic situation in the detection zone (54), the evaluation unit (60) adjusting the information to the driver as a function of one or more predefined information conditions (14, 17, 18) being met, characterized in that the braking means (70) of the vehicle (50) for carrying out the emergency braking process are actuated independently of the driver if the evaluation unit (60) detects that a driver wishes to carry out the emergency braking process, and in that the evaluation unit (60) determines a positional variable which describes a spatial position (xᵢ, yᵢ) of the respective object (i) in relation to the vehicle (50) and/or a relative speed variable which describes the relative speed (v_{rel,i}) between the vehicle (50) and the respective object (i) for each of the objects (i) located in the detection zone (54), in which case, by evaluating the positional variables and/or relative speed variables which have been determined the evaluation unit (60) determines those objects which constitute obstacles for the vehicle (50) with respect to its driving course from the totality of the detected objects (i).
